(19) United States
(12) Patent Application Publication
(10) Pub. No.: US 2005/0265634 A1
(43) Pub. Date: Dec. 1, 2005

(54) Image transmission apparatus, image processing apparatus, image processing system, and image transmission program storage medium

(75) Inventor: Takeshi Katayama, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/138,487

(22) Filed: May 27, 2005

(30) Foreign Application Priority Data
May 27, 2004 (JP) 2004-157612
May 23, 2005 (JP) 2005-149879

(51) Int. Cl. G06K 9/54

(52) U.S. Cl. 382/305; 709/247

(57) ABSTRACT

An image transmission apparatus comprises: a transmission section that transmits images to an image processing apparatus for applying an image processing to the images upon a decision of processing contents; an image selection section that select an image from among the images transmitted from the transmission section in accordance with operation; a processing content obtaining section that obtains from the image processing apparatus the processing contents determined by the image processing apparatus for the image processing applied by the image processing apparatus to the image selected by the image selection section; and an image recording section that stores in a predetermined storage location the image selected by the image selection section and the processing contents obtained by the processing content obtaining section with respect to the image with their association therebetween.

### BACKGROUND OF THE INVENTION

1. Field of the Invention

The present invention relates to an image transmission apparatus for transmitting images, an image processing apparatus for applying image processing to an image transmitted from the image transmission apparatus, an image processing system for applying image processing to an image, and an image transmission program storage medium storing an image transmission program that causes a computer having a function of an image transmission to operate as the transmission apparatus.

2. Description of the Related Art

Recently, while multi-functioning of a portable telephone is advanced, portable telephones having a photographic function of obtaining an image through photography have come into wide use (for example, Japanese Patent Laid Open Gazette TokuKai 2003-319034, FIG. 2, 0018-0031).

As such portable telephones having the multi-function come into wide use, printers, which adapts to print images obtained the portable telephones and/or images transmitted from the portable telephones, come onto the market.

There is frequent such a case that this type of printer is provided with a function of performing an image processing that an image quality of the received image is corrected to an image quality that persons generally feel preferable. In such a case, the printed photography is different from the image obtained through a portable telephone in image quality. Hence, in the event that a user, who favors the printed photography, desires to save the image associated with the photography, it is preferable that the image, which is subjected to the above-mentioned image processing, is stored in a predetermined storage destination in form of information in which the printed photography can be reproduced including the image quality.

By the way, recently, a photographic shop such as a photo studio provides a service that images, which are obtained through an image forming apparatus such as a digital camera and a portable telephone having a photographic function, are stored in a server for image storage. Accordingly, as the storage destination of images subjected to the above-mentioned image processing, it is considered that the server for image storage is used. Transfer of images from the printer to the server can be performed through using a data communication function of the portable telephone.

However, in this case, there is a need of transfers of images, that is, not only transfer of images from the portable telephone to the printer at the time of the printing, but also twice transfer of images from the printer to the portable telephone and further transfer of images from the portable telephone to the server, after the printing. Such transfers of images take much transfer time, and thus the printing processing for photograph including the transfers of the images over three times as mentioned above take much time. This causes a user a pain.

In the above-mentioned description, there is explained a problem involved in saving of images and image quality as well between the portable telephone having the photographic function and the printer. However, such a problem would occur also in the event that images and image quality as well are saved between image transmission apparatuses for transmitting images and image processing apparatuses for applying image processing to images transmitted from the image transmission apparatus.

### SUMMARY OF THE INVENTION

In view of the foregoing, it is an object of the present invention to provide an image transmission apparatus capable of saving information capable of reproducing an image subjected to image processing and the associated image quality as well suppressing time required for processing, an image processing apparatus, an image processing system, and an image transmission program storage medium storing an image transmission program that causes a computer having a function of an image transmission to operate as the transmission apparatus.

To achieve the above-mentioned objects, the present invention provides an image transmission apparatus comprising:
a transmission section that transmits images to an image processing apparatus for applying an image processing to the images upon a decision of processing contents;
an image selection section that select an image from among the images transmitted from the transmission section in accordance with operation;
a processing content obtaining section that obtains from the image processing apparatus the processing contents determined by the image processing apparatus for the image processing applied by the image processing apparatus to the image selected by the image selection section; and
an image recording section that stores in a predetermined storage location the image selected by the image selection section and the processing contents obtained by the processing content obtaining section with respect to the image with their association therebetween.

An image quality of an image is finally determined in accordance with the image processing of the image processing apparatus, and thus information for reproducing the image quality of the image is in the image processing apparatus. Accordingly, in order to save information capable of reproducing the image and the associated image quality as well, first, it is necessary to obtain the information for reproducing the image quality from the image processing apparatus. The information for reproducing the image quality is directly equivalent to the image, which the image processing is applied to. However, according to the image transmission apparatus of the present invention, it is possible to obtain from the image processing apparatus, as the information capable of reproducing the image quality, instead of the image subjected to the image processing, processing contents for the image processing to be executed by the image transmission apparatus, which is expressed by data that is extremely less than the image, with extremely shorter time as compared with a time for obtaining the image itself. Further, according to the image transmission apparatus of the present invention, the processing contents for the image processing and the unprocessed image before applying the image processing by the image processing apparatus, which is selected by the image selection section, are saved into the recording location through their association therebetween. In the event that the image and the image quality as well are reproduced later, the image processing for the processing contents saved in association with the unprocessed image is applied to the unprocessed image, so that the image and the image quality as well are reproduced. In this manner, according to the image transmission apparatus of the present invention, it is possible to save information capable of reproducing the image and the image quality as well with suppressing time required for processing.

In the image transmission apparatus according to the present invention as mentioned above, it is preferable that the image transmission apparatus further comprises a medium access section that accesses to a predetermined recording medium, and the image recording section uses, as the storage location, the recording medium capable of being accessed by the medium access section.

According to the image transmission apparatus as mentioned above, it is sufficient for the image processing apparatus to perform the transmission processing for the image once when the image processing is performed. This feature makes it possible to save the information capable of reproducing the image and the image quality as well with suppressing time required for processing more greatly.

In the image transmission apparatus according to the present invention as mentioned above, it is preferable that the image recording section uses, as the storage location, a recording location capable of being accessed through a communication network.

According to the image transmission apparatus as mentioned above, it is possible to save through for example the communication network a large amount of processing contents and images into a recording location such as a large storage capacity of server.

In the image transmission apparatus according to the present invention as mentioned above, it is preferable that the image transmission apparatus further comprises an image taking section that obtaining an image of a subject through image taking of the subject, and the transmission section transmits the image obtained by the image taking section to the image processing apparatus.

According to the image transmission apparatus as mentioned above, it is possible to readily implement an apparatus such as a portable telephone having an image taking function, for example, in which an image is obtained through photography, and after the image processing apparatus applies a suitable image processing to the image, information capable of reproducing the image subjected to the image processing and the associated image quality as well is saved with suppressing time required for processing.

Further, in the image transmission apparatus according to the present invention as mentioned above, it is preferable that the image recording section stores in the storage location the processing contents as a file other than a file of the image associated with the processing contents.

According to the image transmission apparatus as mentioned above, the processing contents can be stored in a file other than a file storing the image whose data size tends to become large. Accordingly, it is possible to avoid consuming a large quantity of power required for the rewrite of data whose size is large.

Furthermore, in the image transmission apparatus according to the present invention as mentioned above, it is preferable that, for a plurality of images being selected by the image selection section, the image recording section stores in the storage location a plurality of sets of processing contents with respect to the plurality of images as a single common file other than files of the plurality of images.

According to the image transmission apparatus as mentioned above, plural sets of processing contents can be stored as a single common file. The single common file is provided other than files each containing an image whose data size tends to become large. Therefore, even if there are plural sets of processing contents, it is possible to store all of these processing contents with the data size kept small.

To achieve the above-mentioned objects, the present invention provides an image processing apparatus comprising:
a receiving section that receives images from an image transmission apparatus for transmitting images;
a processing content determining section that determines processing contents of image processing to be applied to the images received by the receiving section;
an image processing section that applies image processing for the processing contents determined by the processing content determining section to the image received by the receiving section;
an image selection section that select an image from among the images received by the receiving section in accordance with operation; and
a recording instruction section that transmits the processing contents determined by the processing content determining section with respect to the image selected by the image selection section to the image transmission apparatus and instructs the image transmission apparatus to record the image and the processing contents.

According to the image processing apparatus of the present invention as mentioned above, it is possible for the image transmission apparatus to obtain from the image processing apparatus of the present invention and save, as information for reproducing an image and the associated image quality, the processing contents for image processing, which is extremely less than the image subjected to the image processing, with extremely shorter time as compared with the image. In other words, according to the image processing apparatus of the present invention as mentioned above, it is possible for the image transmission apparatus to record the information capable of reproducing an image and the associated image quality as well with suppressing time required for processing.

In the image processing apparatus according to the present invention as mentioned above, it is preferable that the image processing apparatus further comprises a printing section that outputs an image subjected to the image processing by the image processing section onto a predetermined sheet.

According to the image processing apparatus as mentioned above, it is possible to readily implement an apparatus such as a printer, for example, in which an image is outputted on a predetermined sheet, and the image transmission apparatus may record the information capable of reproducing an image and the associated image quality as well with suppressing time required for processing.

To achieve the above-mentioned objects, the present invention provides an image processing system comprising:
an image transmission apparatus that transmits images;
an image processing apparatus that receives images from the image transmission apparatus and applies an image processing to the images upon a decision of processing contents; and
an image selection section that selects an image in accordance with an operation,
wherein when the image selection section selects the image, the processing contents determined by the image processing apparatus for the image processing applied by the image processing apparatus with respect to the image is transmitted to the image transmission apparatus, and the image transmission apparatus stores in a predetermined storage location the image and the processing contents with their association therebetween.

According to the image processing system according to the present invention as mentioned above, it is possible to save by the transmission apparatus the information capable of reproducing the image subjected to the image processing by the image processing apparatus and the associated image quality as well with suppressing time required for processing.

In the image processing system according to the present invention as mentioned above, it is acceptable that the image selection section selects an image from among the images transmitted by the image transmission apparatus, which is provided on the image transmission apparatus, in accordance with operation.

In the image processing system according to the present invention as mentioned above, it is acceptable that the image selection section selects an image from among the images transmitted from the image transmission apparatus, which is provided on the image processing apparatus, in accordance with operation.

According to the image processing system as mentioned above, it is possible for a user to readily select one's favorite image through operation of the image selection section provided on the image transmission apparatus, or the image selection section provided on the image processing apparatus.

Incidentally, with respect to the image processing system referred to in the present invention, there are simply shown the basic aspect and the associated two aspects as mentioned above. It should be noticed that the image processing system referred to in the present invention includes not only those aspects as mentioned above, but also aspects corresponding to the various aspects of the above-mentioned image transmission apparatus and aspects corresponding to the various aspects of the above-mentioned image processing apparatus.

To achieve the above-mentioned objects, the present invention provides an image transmission program storage medium storing an image transmission program that causes a computer having a function of an image transmission to operate as an image transmission apparatus, when the image transmission program is executed in the computer, the image transmission apparatus comprising:
a transmission section that transmits images to an image processing apparatus for applying an image processing to the images upon a decision of processing contents;
an image selection section that select an image from among the images transmitted from the transmission section in accordance with operation;
a processing content obtaining section that obtains from the image processing apparatus the processing contents determined by the image processing apparatus for the image processing applied by the image processing apparatus to the image selected by the image selection section; and
an image recording section that stores in a predetermined storage location the image selected by the image selection section and the processing contents obtained by the processing content obtaining section with respect to the image with their association therebetween.

According to the image transmission program storage medium storing the image transmission program of the present invention as mentioned above, it is possible to readily implement an image transmission apparatus capable of saving information capable of reproducing an image and the associated image quality as well suppressing time required for processing.

Incidentally, with respect to the image transmission program storage medium storing an image transmission program referred to in the present invention, there are simply shown the basic aspect and the associated two aspects as mentioned above. It should be noticed that the image transmission program storage medium storing an image transmission program referred to in the present invention includes not only those aspects as mentioned above, but also aspects corresponding to the various aspects of the above-mentioned image transmission apparatus.

### BRIEF DESCRIPTION OF THE DRAWINGS

FIG. 1 is a perspective view of a portable telephone in front according to a first embodiment of the image transmission apparatus of the present invention.

FIG. 2 is a perspective view of a portable telephone in back according to the first embodiment of the image transmission apparatus of the present invention.

FIG. 3 is a perspective view of a first image processing system.

FIG. 4 is a view showing a state that an instant film is delivered from a mobile printer while an image is printed on the instant film.

FIG. 5 is a view showing a state that an instant film pack, which accommodates a plurality of instant films, is mounted on a mobile printer.

FIG. 6 is a block diagram of the first image processing system shown in FIG. 3 and FIG. 4 and a simple structure of a server for saving image reproduction data to reproduce images and image quality as well.

FIG. 7 is a conceptual view of a storage section storing a control program according to a first embodiment of the control program storage medium of the present invention, which is also shown in FIG. 6.

FIG. 8 is a view useful for understanding the selection and saving processing to be executed in the first image processing system, which is shown in FIG. 7.

FIG. 9 is a view showing an example of an image processing menu to be displayed on a display screen.

FIG. 10 is a view showing an example of a control menu to be displayed on a display screen.

FIG. 11 is a block diagram useful for understanding an example of an image processing to be executed in a mobile printer.

FIG. 12 is a perspective view of a second image processing system.

FIG. 13 is a block diagram of the second image processing system shown in FIG. 12 and a simple structure of a server for saving image reproduction data to reproduce an image, which is selected as “favorite image”, and image quality as well.

FIG. 14 is a view useful for understanding the selection and saving processing to be executed in the second image processing system.

FIG. 15 is a perspective view of a third image processing system.

FIG. 16 is a block diagram of the third image processing system shown in FIG. 15.

FIG. 17 is a conceptual view of a storage section storing a control program according to a second embodiment of the image transmission program storage medium of the present invention, which is also shown in FIG. 16.

FIG. 18 is a view useful for understanding the selection and saving processing to be executed in the third image processing system, which is shown in FIG. 16.

FIG. 19 is a diagram showing an example of the data structure of a recording medium in which image data and image quality reproduction information are stored during the selection and saving processing.

FIG. 20 is a diagram showing an example of an ASSET MANIFEST file.

### DETAILED DESCRIPTION OF THE INVENTION

Embodiments of the present invention will be described with reference to the accompanying drawings.

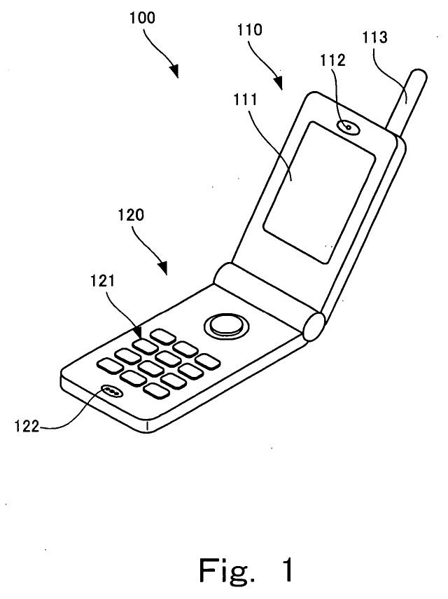

First, there will be explained in externals a portable telephone of a first embodiment of an image transmission apparatus, a mobile printer for printing an image in accordance with image data transmitted from the portable telephone, and a first image processing system comprising the portable telephone and the mobile printer, which is a first embodiment of the image processing system f the present invention, in conjunction with FIG. 1 to FIG. 5.

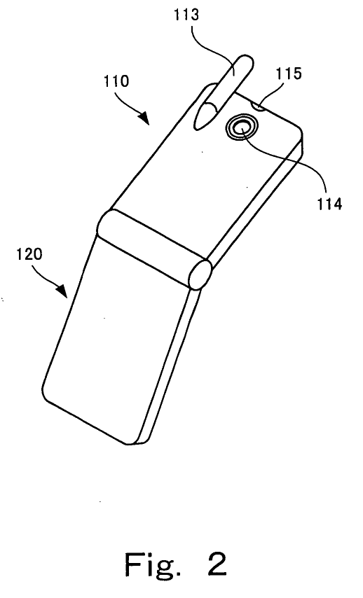

FIG. 1 is a perspective view of a portable telephone in front according to a first embodiment of the image transmission apparatus of the present invention. FIG. 2 is a perspective view of the same in back.

A portable telephone 100 comprises an upper portion 110 and a lower portion 120, and is of a folding type.

The upper portion 110 of the portable telephone 100 comprises a display screen 111, a sound reproduction slot 112, an antenna 113, an image-taking lens 114 disposed at the back, and an infrared transmit-receive section 115 disposed at the back for an infrared communication. The lower portion 120 comprises operation keys 121 and a sound input slot 122.

In response to an operation of a user, the portable telephone 100 takes a photograph of the subject by an image taking section (which will be described later) having the image taking lens 114, so that the portable telephone 100 generates image data representative of a color image with three colors of R (red), G (green) and B (blue). Further, in response to an operation of a user, the portable telephone 100 can transmit the image data from the infrared transmit-receive section 115 to a mobile printer (which will be described later) through the infrared communication.

According to the portable telephone 100, in the event that a user, who sees an image printed by a mobile printer, favorites the printed image, upon receipt of an operation from the user, it is possible to obtain from the mobile printer an image quality reproduction information (which will be described later) for reproducing image quality of the image. Obtaining of the image quality reproduction information is implemented in such a manner that first the infrared transmit-receive section 115 sends an instruction signal to instruct a transmission of the image quality reproduction information through the infrared communication, and then the infrared trahsmit-receive section 115 receives the image quality reproduction information transmitted from the mobile printer through the infrared communication in accordance with the instruction signal.

Further, according to the portable telephone 100, the image quality reproduction information, which is obtained in the infrared transmit-receive section 115, is associated with image data transmitted from the portable telephone 100 to the mobile printer, which corresponds to the image quality reproduction information, so that image reproduction data for reproducing an image and an image quality as well is created and transmitted to a predetermined server. A transmission of the image reproduction data to the server is implemented by a function with which the portable telephone 100 is provided, the function being the equivalent to the data transmission function with which the conventional portable telephone is provided.

Next, there will be explained in externals a first image processing system including the portable telephone 100.

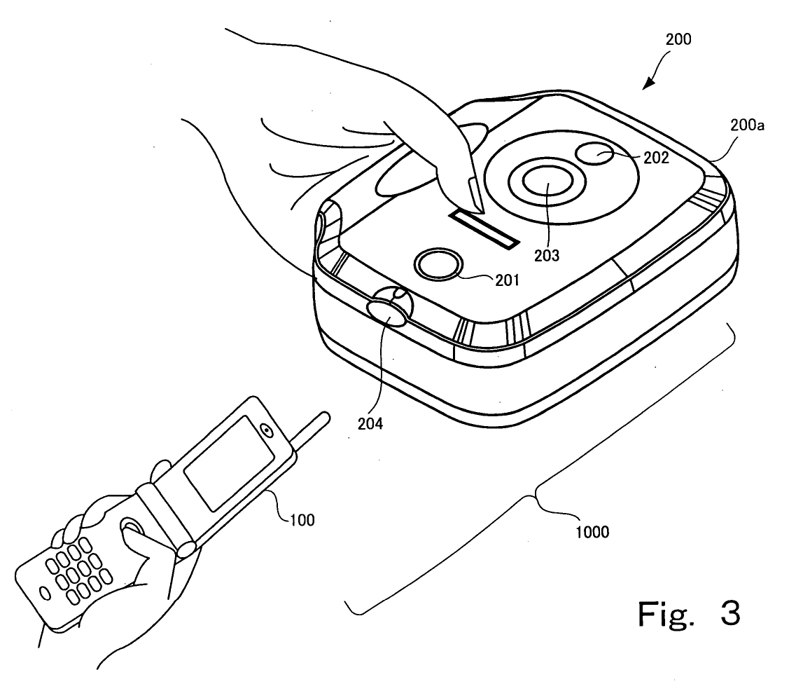

FIG. 3 is a perspective view of a first image processing system.

A first image processing system 1000 comprises the portable telephone 100, which is also shown in FIG. 1 and FIG. 2, and a mobile printer 200 for printing an image in accordance with image data transmitted from the portable telephone 100. The mobile printer 200 corresponds to an example of an image processing apparatus in an image processing system of the present invention. The first image processing system 1000 corresponds to an image processing system in which “image selection section is provided on the image transmission apparatus” referred to in the present invention.

The mobile printer 200 adapts to print an image on an instant film sheet in accordance with image data transmitted from the portable telephone 100 through the infrared communication. When a user desires re-print of the image once printed, the mobile printer 200 is able to perform the re-print in accordance with a simple operation by the user (which will be described later), without necessity of the re-transmission of the image data representative of the image from the portable telephone 100.

The mobile printer 200 is compact and light. As seen from FIG. 3, it is possible for a user to perform printing of an image having both the mobile printer 200 and the portable telephone 100 by one's hands. A pack of instant film sheets is mounted inside a cover member 200a of the mobile printer 200. When printing is carried out, the instant film sheets are delivered one by one from the pack to print an image.

On the top of the cover member 200a of the mobile printer 200, there are provided a power switch 201 for instructing turn on and turn off of a power of the mobile printer 200, a re-print switch 202 for instructing the re-print, and an LCD panel 203 for indicating information such as the number of residual of the instant film sheets of the pack.

At the side of the cover member 200a, there is provided an infrared transmit-receive section 204 for transmitting and receiving infrared. As mentioned above, the portable telephone 100 transmits through the infrared communication image data and an instruction signal to instruct the transmission of the image quality reproduction information. The infrared transmit-receive section 204 receives those data and transmits the image quality reproduction information to the portable telephone 100.

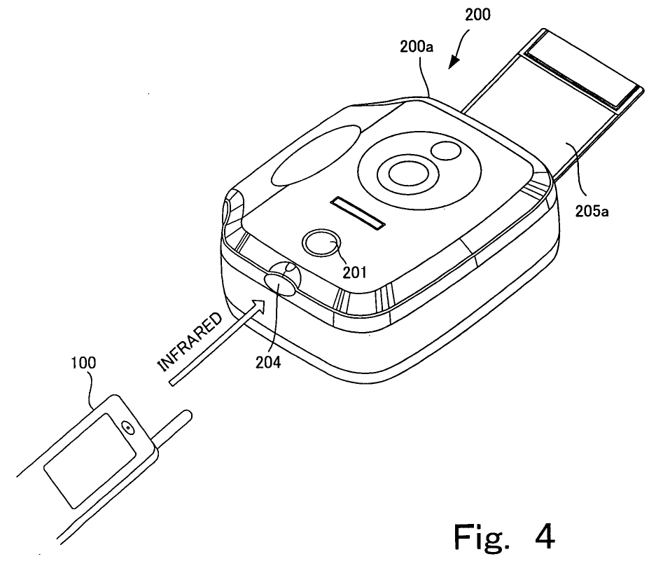

FIG. 4 is a view showing a state that an instant film is delivered from a mobile printer while an image is printed on the instant film.

According to the mobile printer 200, when the infrared transmit-receive section 204 receives image data transmitted from the portable telephone 100 through the infrared communication, an image processing section (here not illustrated) applies a predetermined image processing to the image data. The image processing will be described later. When the image processing is over, printing is carried out on an instant film 205a in accordance with the processed image data, and the instant film 205a is delivered. When a user depresses the re-print switch 202 after execution of the printing, the same image as the image printed immediately before is printed on another instant film 205a.

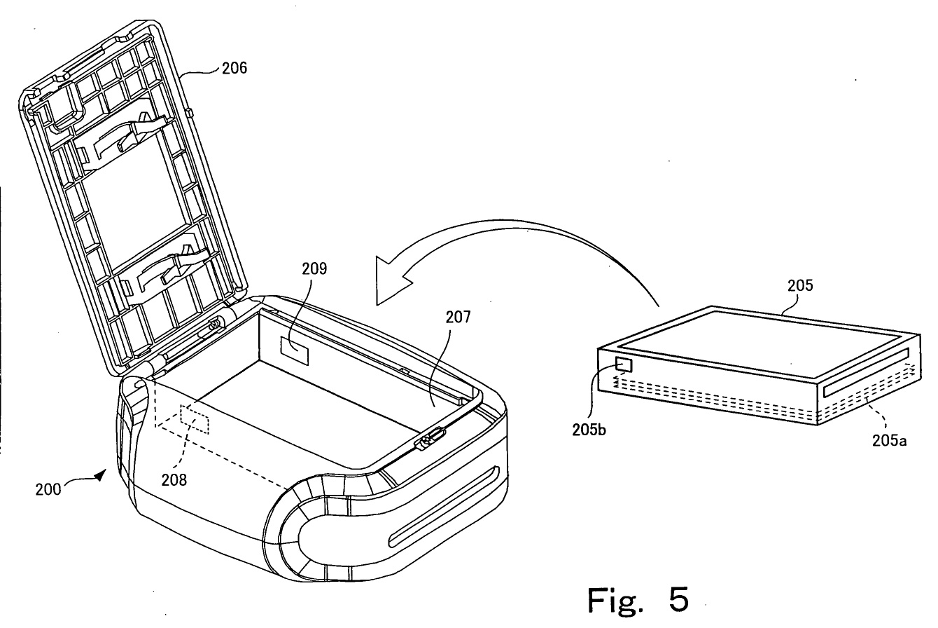

FIG. 5 is a view showing a state that an instant film pack, which accommodates a plurality of instant films, is mounted on a mobile printer.

On the back of the mobile printer 200, there is provided a film mounting chamber 207 for mounting an instant film pack 205 for accommodating a plurality of instant films 205a. When the instant film pack 205 is mounted, a film door 206, which covers the film mounting chamber 207, is opened to mount the instant film pack 205 onto the film mounting chamber 207.

Affixed to the instant film pack 205 is an IC tag 205b recording information such as sort, size and manufacture lot of the instant film 205a stored in the instant film pack 205. In the film mounting chamber 207, there are provided an IC tag reading section 208 for reading information recorded on the IC tag 205b, and an environmental sensor 209 for detecting an environment such as the temperature of the film mounting chamber 207.

An image quality of the image printed on the instant film 205a will be varied in accordance with environments such as sort, size and manufacture lot of the instant film 205a, and the temperature at the time of printing. According to the mobile printer 200 of the present embodiment, there is performed an image processing in such a manner that the optimum image quality is obtained in accordance with various sorts of information read by the IC tag reading section 208 and the detection results of the environmental sensor 209.

With the above-mentioned description, there is terminated the explanations for the portable telephone 100, the mobile printer 200 and the first image processing system 1000 in their externals.

Here, an aspect of the portable telephone 100 resides in selection and saving functions of saving of image reproduction data (which will be described later) for reproducing the image printed by the mobile printer 200 and the image quality as well into a predetermined server. Hereinafter, there will be described the selection and saving functions with reference to the block diagram of the first image processing system 1000 comprising the portable telephone 100 and the mobile printer 200.

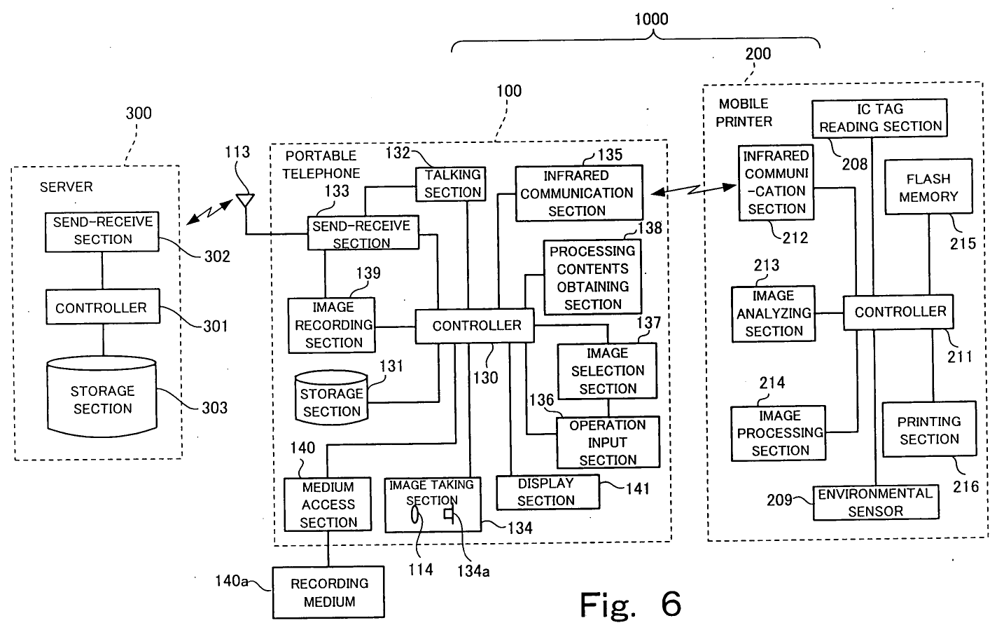

FIG. 6 is a block diagram of the first image processing system shown in FIG. 3 and FIG. 4 and a simple structure of a server for saving image reproduction data to reproduce images and image quality as well.

FIG. 6 shows the portable telephone 100, the mobile printer 200 and a server 300. The server 300 corresponds to an example of the recording place referred to in the present invention.

First, there will be explained the internal structure of the mobile printer 200.

The mobile printer 200 comprises a controller 211, an infrared communication section 212, an image analyzing section 213, an image processing section 214, a flash memory 215, a printing section 216, the IC tag reading section 208 (also shown in FIG. 5), and the environmental sensor 209 (also shown in FIG. 5).

The controller 211 of the mobile printer 200 controls operations of the respective elements as will be described hereinafter.

The infrared communication section 212 of the mobile printer 200 is provided with the infrared transmit-receive section 204. The infrared communication section 212 performs the receiving of the image data transmitted from the portable telephone 100 through the infrared communication and an instruction signal to instruct the transmission of image quality reproduction information (which will be described later), and the transmission of the image quality reproduction information.

The image analyzing section 213 of the mobile printer 200 performs analysis as to brightness, white balance and sharpness of an image represented by the image data received by the infrared communication section 212.

The IC tag reading section 208 of the mobile printer 200 reads information as to sort, size and manufacture lot of the instant film 205a stored in the instant film pack 205, which information is recorded on the IC tag 205b affixed to the instant film pack 205 mounted on the mobile printer 200.

The environmental sensor 209 of the mobile printer 200 adapts to detect environments such as temperatures of the mobile printer 200.

The image processing section 214 of the mobile printer 200 applies image processing as set forth below to the image data received by the infrared communication section 212.

First, the image processing section 214 performs an image optimization processing, such as an automatic exposure correcting processing (an AE correcting processing), an automatic white balance correcting processing (an AWB correcting processing), and a sharpness processing, in which brightness, white balance and sharpness of an image are corrected to brightness, white balance and sharpness that are agreeable to a person, in accordance with the analyzing result obtained in the image analyzing section 213, respectively. In the image optimization processing, the various sorts of information read by the IC tag reading section 208 and the detection result of the environmental sensor 209 are used to correct brightness, white balance and sharpness of an image to the optimum, respectively.

Further, the image processing section 214 adapts also to perform an image processing being for an effect on enjoyment, for example, a soft focus, which is designated by a user through operation to the portable telephone 100 as will be described later. In the event that a user does not issue any designation for the image processing, the image processing section 214 performs only the AE correcting processing, the AWB correcting processing, and the sharpness processing.

Here, transmitted to the flash memory 215 are the information obtained in the IC tag reading section 208, the detection result obtained in the environmental sensor 209, various sorts of correcting values used in the AE correcting processing, the AWB correcting processing, and the sharpness processing, and various sorts of processing parameters used in the above-mentioned image processing being for an effect on enjoyment. Those various sorts of information correspond to the image quality reproduction information for reproducing image quality of the image, referred to in the present embodiment, and also correspond to an example of “processing content determined by the image processing apparatus, of image processing applied by the image processing apparatus” referred to in the present invention.

The flash memory 215 of the mobile printer 200 stores various sorts of processing programs for executing the above-mentioned image optimization processing and the image processing such as soft focus. When the processing is carried out, those processing programs are selectively read from the flash memory 215 to execute the associated processing. Further the flash memory 215 stores the processed image data, which is subjected to image processing by the image processing section 214. In the mobile printer 200, when the re-print switch 202 is depressed, the above-mentioned processed image data is read from the flash memory 215 so that the mobile printer 200 performs the re-print.

Furthermore the flash memory 215 stores the above-mentioned image quality reproduction information. In the event that the portable telephone 100 transmits to the mobile printer 200 an instruction signal to instruct transmission of the image quality reproduction information with respect to the image now printed by the mobile printer 200, the image quality reproduction information is read from the flash memory 215 and then transmitted to the portable telephone 100.

The printing section 216 of the mobile printer 200 prints an image represented by the above-mentioned processed image data on the instant film sheet and is delivered to the exterior of the mobile printer 200.

Next, there will be explained the internal structure of the server 300.

The server 300 shown in FIG. 6 is connected to a communication network (not illustrated), and it is possible to access the server 300 from the portable telephone 100 through the communication network. The server 300 comprises a controller 301, a receiving section 302, and a storage section 303.

According to the present embodiment, with respect to an image (that is referred to as “favorite image” hereinafter), which is a user's desired image in save, of images to be printed by the mobile printer 200, as will be described later, the portable telephone 100 creates image reproduction data in which the above-mentioned image quality reproduction information is associated with image data representative of un-processed image, which is not yet subjected to the image processing, which image data is possessed by the portable telephone 100. The server 300 saves the image reproduction data.

The controller 301 of the server 300 controls the respective elements as will be described hereinafter.

The receiving section 302 of the server 300 receives the image reproduction data transmitted from the portable telephone 100.

The storage section 303 stores the image reproduction data received by the receiving section 302.

Next, there will be explained the internal structure of the portable telephone 100.

The portable telephone 100 comprises a controller 130, a storage section 131, a talking section 132, a send-receive section 133, an image taking section 134, an infrared communication section 135, an operation input section 136, an image selection section 137, a processing content obtaining section 138, an image recording section 139, a medium access section 140, a display section 141, and the antenna 113 that is also shown in FIG. 1 and FIG. 2.

The image taking section 134, the infrared communication section 135, the processing content obtaining section 138, the image recording section 139, and the medium access section 140 correspond to the examples of the image taking section, the transmission section, the processing content obtaining section, the image recording section, and the medium access section of the image transmission apparatus of the present invention, respectively. The combination of the operation input section 136 and the image selection section 137 corresponds to an example of the image selection section of the present invention.

The storage section 131 stores a control program for control of the operations of the portable telephone 100 in its entirety. When a power is supplied to the portable telephone 100, the controller 130 reads the control program from the storage section 131 to perform the operational control.

The control program corresponds to an image transmission program stored in a first embodiment of the control program storage medium according to the present invention, which causes the portable telephone 100 to operate as the first embodiment of the image transmission apparatus according to the present invention.

Hereinafter, before the explanation of the respective elements of the portable telephone 100, there will be explained the control program.

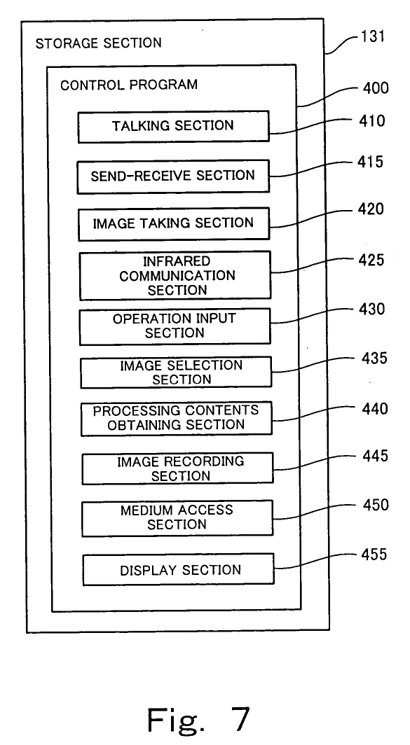

FIG. 7 is a conceptual view of a storage section storing the control program stored in a first embodiment of the image transmission program storage medium according to the present invention, which is also shown in FIG. 6.

A control program 400 comprises a talking section 410, a send-receive section 415, an image taking section 420, an infrared communication section 425, an operation input section 430, an image selection section 435, a processing content obtaining section 440, an image recording section 445, a medium access section 450, and a display section 455. The image taking section 420, the infrared communication section 425, the processing content obtaining section 440, and the image recording section 445 constitute examples of the image taking section, the transmitting section, the processing content obtaining section, and the image recording section referred to in the present invention, respectively in functional combinations with the hardware of the portable telephone 100 and the OS. The combination of the an operation input section 430 and the image selection section 435 constitutes an example of the image selection section referred to in the present invention. Details of the respective sections of the control program 400 will be described together with functions of the respective elements of the portable telephone 100, which is the first embodiment of the image transmission apparatus of the present invention shown in FIG. 6.

Now returning to FIG. 6, there will be explained the respective elements of the portable telephone 100.

The controller 130 of the portable telephone 100 controls operations of the respective elements of the portable telephone 100 in accordance with the control program 400.

The storage section 131 of the portable telephone 100 stores the control program 400.

The talking section 132 of the portable telephone 100 serves as a telephone in the portable telephone 100 together with the send-receive section 133 and the antenna 113, and has a sound reproduction slot 112 and a sound input slot 122. The talking section 132 adapts to convert an audio signal received through the send-receive section 133 and the antenna 113 to sounds and output the sounds from the sound reproduction slot 112. The talking section 132 also adapts to convert sounds entered from the sound input slot 122 to an audio signal and transmit the audio signal in form of a radio wave through the send-receive section 133 and the antenna 113.

The image taking section 134 of the portable telephone 100 has an image taking lens 114 that is shown also in FIG. 2, and an imaging device 134a for converting a subject light projected through the image taking lens 114. The image taking section 134 generates image data representative of an image of the subject in accordance with an image signal obtained through the imaging device 134a. The thus generated image data is recorded on a recording medium 140a by the medium access section 140 as will be described later.

The infrared communication section 135 of the portable telephone 100 has the infrared transmit-receive section 115. The infrared communication section 135 transmits image data generated in the image taking section 134 and various sorts of instruction signals for the mobile printer 200 in form of infrared. The infrared communication section 135 adapts also to receive information transmitted in accordance with the instruction signals.

The operation input section 136 of the portable telephone 100 has the operation keys 121. Various sorts of instructions from a user, for example, an instruction of the transmission of image data, may be entered through the operation keys 121.

The image selection section 137 of the portable telephone 100 adapts to determine as to whether the image transmitted to the mobile printer 200 and then printed is selected as the “favorite image”, in accordance with the user's operation.

In the event that the mobile printer 200 prints an image, and the image selection section 137 selects the printed image as the “favorite image”, the processing content obtaining section 138 of the portable telephone 100 first transmits an instruction signal for instructing transmission of the image quality reproduction information associated with the image through the infrared communication section 135 to the mobile printer 200, and then obtains through the infrared communication section 135 the image quality reproduction information transmitted from the mobile printer 200 in accordance with the instruction signal.

The image recording section 139 of the portable telephone 100 creates image reproduction data to reproduce the printed image and image quality as well, regarding the image selected as the “favorite image”, with an association of the image quality reproduction information obtained in the processing content obtaining section 138 with the image data representative of the un-processed image. The image reproduction data thus generated is transmitted through the send-receive section 133 and the antenna 113 to the server 300 in accordance with the instruction of the image recording section 139. The image reproduction data is recorded on the recording medium 140a by the medium access section 140 in accordance with the instruction of the image recording section 139.

The medium access section 140 of the portable telephone 100 records the image data obtained in the image taking section 134 and the image reproduction data on the recording medium 140a that is detachably mounted on the portable telephone 100.

The display section 141 of the portable telephone 100 has the display screen 111. On the display screen 111, there may be displayed an image represented by the image data obtained by the image taking section 134, various sorts of menus through the user's operation for the operation input section 136, the icon for operation, and etc.

With the above-mentioned description, there is terminated the explanations for the first image processing system 1000 in its internal structure. Next, there will be explained the selection and saving processing for saving the image reproduction data into the server 300.

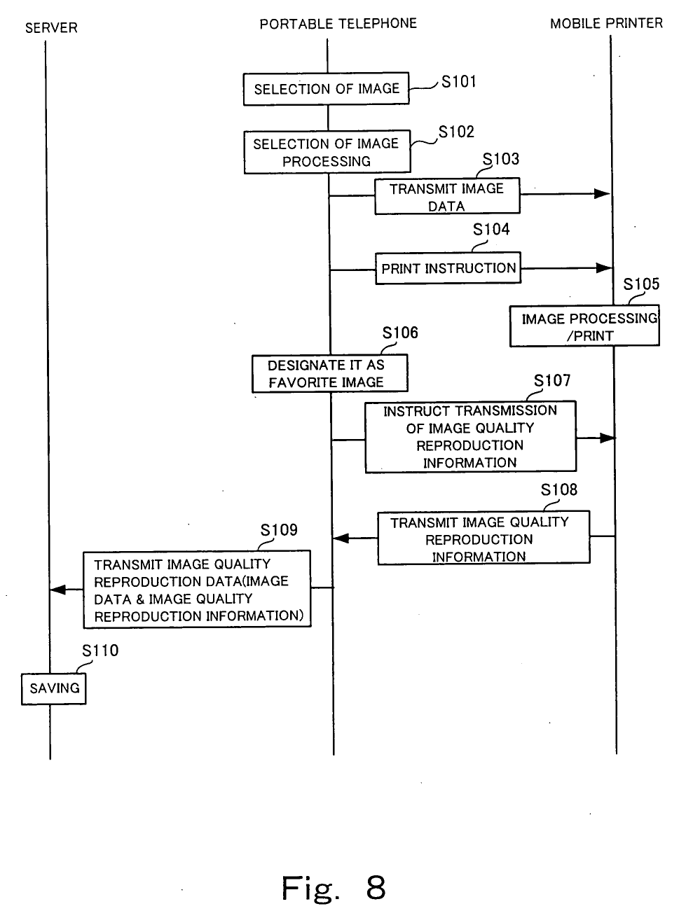

FIG. 8 is a view useful for understanding the selection and saving processing to be executed in the first image processing system, which is shown in FIG. 7.

The selection and saving processing shown in FIG. 8 starts when a user's operation of the operation keys 121 of the portable telephone 100 notifies the portable telephone 100 of a matter that it is requested that the mobile printer 200 is used to print an image.

When the selection and saving processing starts, first, there is displayed on the display screen 111 of the portable telephone 100 a message that encourages a user to select an image to be printed by the mobile printer 200, and the selection of the image is performed in accordance with the message (step S101).

Next, there are displayed on the display screen 111 a message that encourages a user to select image processing to be applied to the selected image by the mobile printer 200 of a predetermined image processing menu, and the image processing menu, and the selection of the image processing is performed in accordance with the message (step S102). Further, according to the processing of the step S102, there is also displayed on the display screen 111 a control menu for controlling processing contents of the image processing to a desired processing content, for example, what intensity a desired image processing is applied to an image with, and a user selects the desired processing content from the control menu.

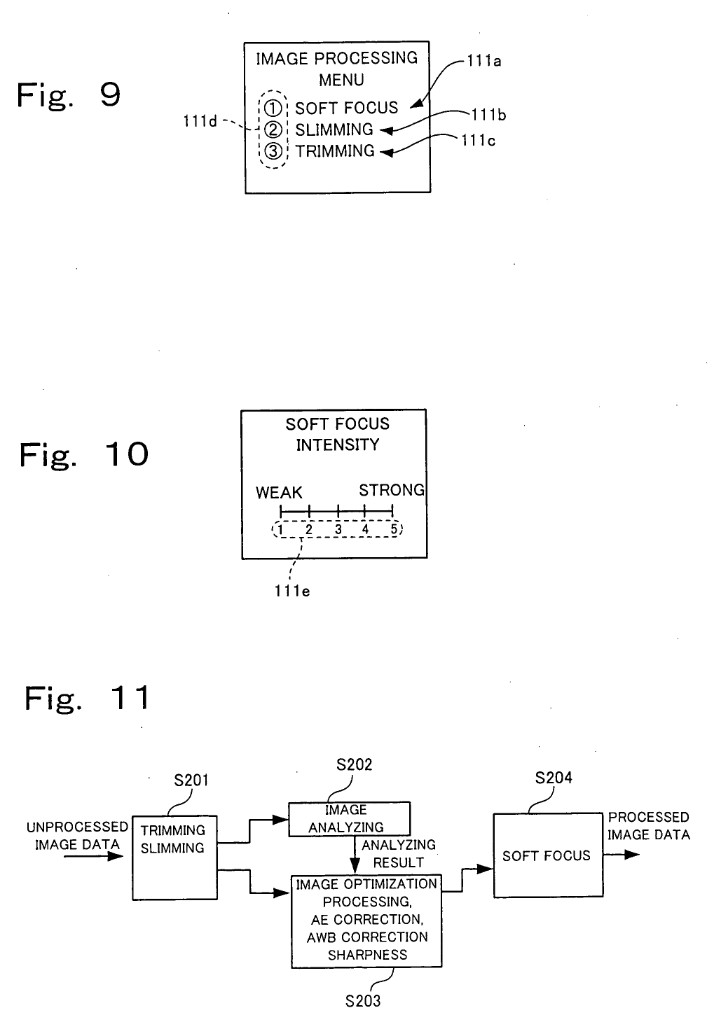

FIG. 9 is a view showing an example of an image-processing menu to be displayed on a display screen. FIG. 10 is a view showing an example of a control menu to be displayed on a display screen.

FIG. 9 shows an image-processing menu comprising three sorts of processing of a soft focus 111a for causing an image to be a bit out of focus intentionally aiming to get a visual effect for enjoyment, a slimming 111b for altering the ratio of length and breadth of an image aiming to get a visual effect for enjoyment, and a trimming 111c for designating an image area to be printed in the whole image aiming to get a visual effect for enjoyment. According to the present embodiment, a user selects a desired image processing in such a manner that the user operates the operation keys 121 to select a number associated with a desired image processing from among numbers 111d associated with the respective sorts of image processing.

FIG. 10 shows, by way of an example of the control menu, a parameter input screen for encouraging a user to input a parameter as to a control of the intensity of the soft focus, that is, the degree of out of focus for an image. According to the example of FIG. 10, a user can select a desired intensity from among five steps of intensity. A user selects, from among numbers 111e representative of five steps of intensity, a number representative of a desired intensity through operation of the operation keys 121. According to the present embodiment, also with respect to other two sorts of image processing (the slimming and the trimming), in a similar fashion to that of the soft focus, it is so arranged that a number indicative of the degree of processing is selected.

Further, according to the present embodiment, it is possible for a user to select a plurality of sorts of desired image processing from the above-mentioned image-processing menu, or alternatively it is acceptable to select nothing. In the event that a user selects a plurality of sorts of image processing, the above-mentioned image-processing menu is displayed for each image processing to determine the degree of the processing. In the event that a user selects no image processing, the mobile printer 200 applies to an image only the image optimization processing, such as an automatic exposure correcting processing (an AE correcting processing), an automatic white balance correcting processing (an AWB correcting processing), and a sharpness processing.

Now again returning to FIG. 8, the explanation will be continued.

When the processing of the step S102 determines an image processing to be applied to an image and the degree of the processing, there is displayed on the display screen 111 of the portable telephone 100 a message that encourages a user to perform a key operation to instruct a transmission of image data through directing the infrared transmit-receive section 115 of the portable telephone 100 to the infrared transmit-receive section 204 of the mobile printer 200. When the user performs the operation in accordance with the message, first, image data representative of an image selected by the processing of the step S101 is transmitted from the portable telephone 100 to the mobile printer 200 through the infrared communication (step S103), then image processing including the processing determined by the processing of the step S102 is applied to the image represented by the image data so that an instruction signal for instructing to print the processed image is transmitted through the infrared communication (step S104). Upon receipt of the instruction signal, the mobile printer 200 applies an image processing to the image represented by the image data, so that the processed image is printed on the instant film 205a (step S105).

FIG. 11 is a block diagram useful for understanding an example of an image processing to be executed in a mobile printer.

FIG. 11 is a block diagram useful for understanding an image processing to be executed in the mobile printer 200 in the event that a user designates, as a desired image processing, all of the three sorts of processing shown in FIG. 9.

According to this image processing, first, two sorts of processing of the trimming and the slimming are applied to the unprocessed image data, and image enlargement and reduction processing is performed in accordance with the size of the instant film set to the mobile printer 200 (step S201).

Next, with respect to image data subjected to the processing of the step S201, an image represented by the image data is analyzed to determine brightness, white balance and sharpness of the image (step S202).

Here, the above-mentioned image optimization processing is applied to the image data subjected to the processing of the step S201 through using the analysis result determined by the processing of the step S202, information such as sort, size and manufacture lot of the instant film 205a on which an image is to be printed, which are read by the an IC tag reading section 208 of the mobile printer 200, and the environmental sensor 209 of the mobile printer 200 (step S203). Further, the soft focus is applied to the image data subjected to the image optimization processing (the step S203). And then an image is printed in accordance with the processed image data subjected to the processing of the step S204.

Now again returning to FIG. 8, the explanation will be continued.0

In the portable telephone 100, after a predetermined time elapses since an instruction signal for instructing printing is transmitted in accordance with the processing of the step S104, there is displayed on the display screen 111 a message that inquires of a user whether the user selects the now printed image as the “favorite image”, so that the user performs the input operation in accordance with the message (step S106). In the event that the user selects the now printed image as the “favorite image” in the processing of the step S106, there is also displayed on the display screen 111 a message that instructs a user to perform an operation notifying the mobile printer 200 of a matter of the selection through directing the infrared transmit-receive section 115 of the portable telephone 100 to the infrared transmit-receive section 204 of the mobile printer 200.

In the event that it is informed that the user does not select the now printed image as the “favorite image” in the processing of the step S106, the processing of FIG. 8 is terminated. On the other hand, in the event that it is informed that the user selects the now printed image as the “favorite image”, the process goes to the subsequent processing (step S107).

According to the processing of the step S107, an instruction signal for instructing that the above-mentioned image quality reproduction information, which is selected as the “favorite image” and is associated with the now printed image, is transmitted to the portable telephone 100, is transmitted from the mobile printer 200 to the portable telephone 100. Upon receipt of the instruction signal, the mobile printer 200 transmits the image quality reproduction information to the portable telephone 100 (step S108).

Upon receipt of the image quality reproduction information, the portable telephone 100 creates image reproduction data through an association of the image quality reproduction information with image data representative of the unprocessed image corresponding to the selected image as the “favorite image”, and transmits the thus created image reproduction data to the server 300 (step S109). The server 300 saves therein the image reproduction data (step S110).

In the event that the image, which is represented by the image reproduction data thus saved, is re-printed, the image processing is applied to the image data representative of the unprocessed image constituting the image reproduction data through using the image quality reproduction information constituting the image reproduction data. This feature makes it possible to reproduce the image and the image quality.

A time required for transmission of the image quality reproduction information, which is executed in the step S108, is greatly shorter as compared with a time required for transmission of the processed image data subjected to the image processing, which directly represents the selected image as the “favorite image” for instance, to the portable telephone 100 as it is.

As mentioned above, according to the present embodiment, it is possible to save the image reproduction data for reproducing an image and the associated image quality as well through suppressing a time required for processing.

According to the above-explained description, the portable telephone 100 that is the first embodiment of the image transmission apparatus of the present invention, which constitutes the first image processing system 1000 that is a first embodiment of the image processing system of the present invention, is provided with the image selection section 137 for selecting, when a user favorites an image printed by the mobile printer 200, the image as the “favorite image” upon receipt of an instruction from the user. However, an image processing system of the present invention is not restricted to the first embodiment of the image processing system as mentioned above. It is acceptable that the mobile printer is provided with an element that is equivalent in function to the image selection section 137 with which the portable telephone 100 is provided.

Hereinafter, there will be explained a second image processing system, which is a second image processing system of the present invention. The second image processing system is the same as the first image processing system except for a different point that the apparatus having the selection function of the “favorite image” is the mobile printer but not the portable telephone. Hereinafter, there will be explained only the different points, omitting redundant explanation.

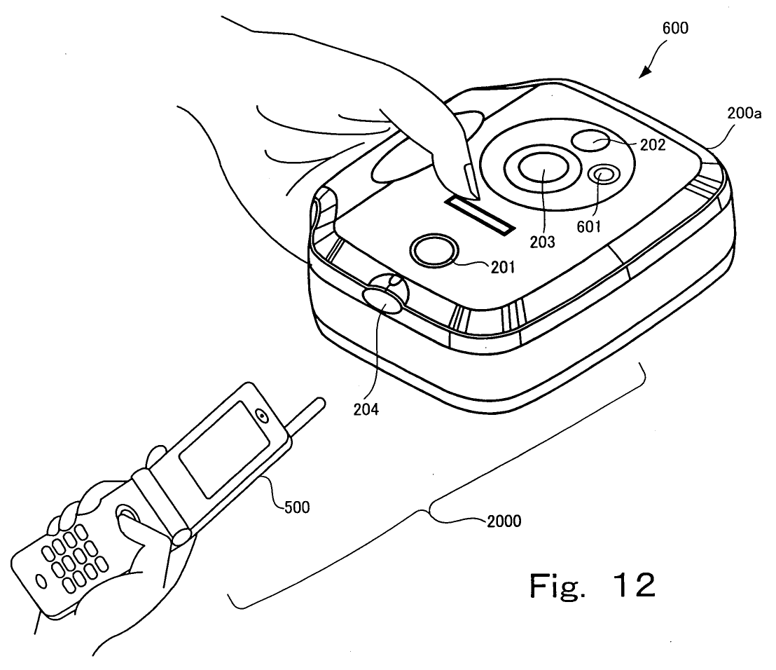

FIG. 12 is a perspective view of a second image processing system.

A second image processing system 2000 comprises a portable telephone 500 and a mobile printer 600 for printing an image in accordance with image data transmitted from the portable telephone 500, which mobile printer is an embodiment of the image processing apparatus of the present invention. The portable telephone 500 corresponds to an example of the image transmission apparatus in the image processing system of the present invention. The second image processing system 2000 corresponds to an example of the image processing system in which “image selection included in the image processing apparatus” referred to in the present invention. In FIG. 12, the same reference numbers as those of FIG. 3 denotes the same parts.

The second image processing system 2000 shown in FIG. 12 is substantially the same as the first image processing system 1000 shown in FIG. 3 in external appearance, but be different from the first image processing system 1000 in the point that an image selection switch 601 for selecting a printed image as the “favorite image” is provided on the top of a cover member 200a of the mobile printer 600.

Next, there will be explained the structure of the second image processing system 2000.

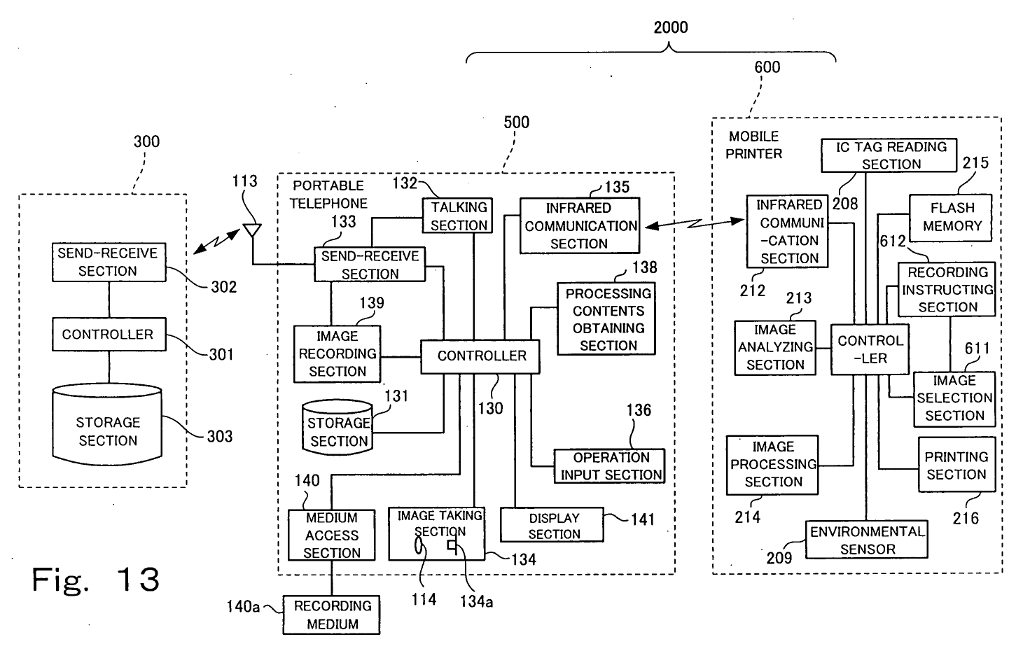

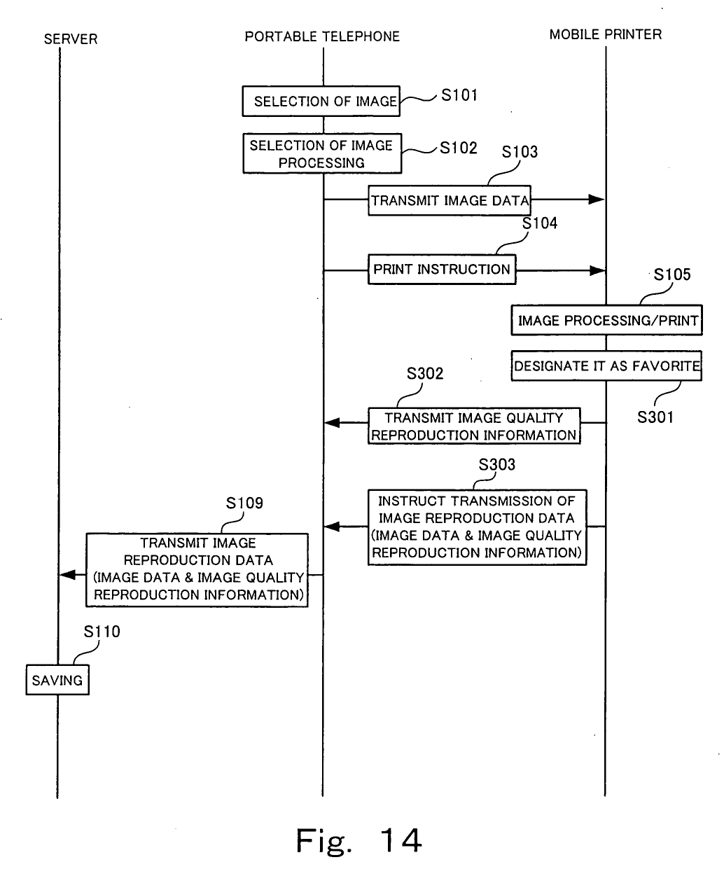

FIG. 13 is a block diagram of the second image processing system shown in FIG. 12 and a simple structure of a server for saving image reproduction data to reproduce an image, which is selected as “favorite image”, and image quality as well. In FIG. 13, the same reference numbers as those of FIG. 6 denotes the same parts.

The second image processing system 2000 shown in FIG. 12 is different from the first image processing system 1000 shown in FIG. 6 in the following points. That is, according to the second image processing system 2000, the portable telephone 500 is not provided with the image selection section 137 with which the portable telephone 100 constituting the first image processing system 1000 is provided, but the mobile printer 600 is provided with an image selection section 611. The mobile printer 600 is provided with the image selection section 611 and a recording instruction section 612 as well.

The infrared communication section 212 and the printing section 216, which are explained in detail with reference to FIG. 6, correspond to the examples of the receiving section and the printing section of the image processing apparatus of the present invention, respectively. The combination of the image analyzing section 213 and the image processing section 214 corresponds to an example of the combination processing contents determination section and the image processing section of the image processing apparatus of the present invention. The image selection section 611 corresponds to an example of the image selection section of the image processing apparatus of the present invention. The combination of the recording instruction section 612 and the infrared communication section 212 corresponds to an example of the recording instruction of the image processing apparatus of the present invention.

The image selection section 611 of the mobile printer 600 adapts to select an image printed by the mobile printer 600 as the “favorite image” in accordance with the user's operation for the image selection switch shown in FIG. 12.

With respect to the image selected as the “favorite image” by the image selection section 611, the infrared communication section 212 transmits to the portable telephone 500 the image quality reproduction information comprising various sorts of information used in the image processing applied to the image by the image processing section 214, in accordance with the instruction of the recording instruction section 612 of the mobile printer 600. The infrared communication section 212 further transmits to the portable telephone 500 an instruction signal to instruct the server 300 to record image reproduction data for reproducing the “favorite image” and the associated image quality as well, in which the above-mentioned image quality reproduction information is associated with image data representative of unprocessed image associated with the “favorite image”, which is not yet subjected to the image processing.

Next, there will be explained selection and saving processing for saving the image reproduction data to the server 300, which is executed in the second image processing system 2000.

FIG. 14 is a view useful for understanding the selection and saving processing to be executed in the second image processing system.

The selection and saving processing shown in FIG. 14 is different from the selection and saving processing shown in FIG. 8 in the point that the mobile printer 200 performs the selection processing for selecting the printed image as the “favorite image”, in accordance with an operation of a user. That is, according to the selection and saving processing shown in FIG. 14, after the mobile printer 200 completes the image processing and the printing (step S105), there is displayed on the LCD panel 203 of the mobile printer 600 a message that inquires of a user whether the user selects the now printed image as the “favorite image”, and the user performs the input operation in accordance with the message (step S301). According to the processing of the step S301, in the event that the user selects the now printed image as the “favorite image”, there is displayed on the LCD panel 203 a message instructing the user to perform the operation for an acceptance of the selection of the now printed image as the “favorite image” through directing the infrared transmit-receive section 115 of the portable telephone 500 to the infrared transmit-receive section 204 of the mobile printer 600. In the step S301, in the event that the now printed image is selected as the “favorite image”, image quality reproduction information comprising various sorts of information used in the processing of the step S105 is transmitted from the mobile printer 600 to the portable telephone 500 (step S302). The mobile printer 600 further transmits to the portable telephone 500 an instruction signal to instruct the server 300 to record image reproduction data for reproducing the “favorite image” and the associated image quality as well, in which the above-mentioned image quality reproduction information is associated with image data representative of unprocessed image associated with the “favorite image”, which is not yet subjected to the image processing (step S303).

Upon receipt of the image quality reproduction information and the instruction signal, the portable telephone 500 creates the image reproduction data and transmits the same to the server 300. The server 300 records the image reproduction data. When the “favorite image” is re-printed later, the image reproduction data is used to reproduce the “favorite image” and the associated image quality as well.

A time required for transmission of the image quality reproduction information, which is executed in the step S302, is greatly shorter as compared with a time required for transmission of the processed image data subjected to the image processing, which directly represents the printed image for instance, to the portable telephone 100 as it is.

As mentioned above, according to the second embodiment too, it is possible to save the image reproduction data for reproducing the “favorite image” and the associated image quality as well through suppressing a time required for processing.

In the image processing systems 1000 and 2000 of the first and second embodiments described so far, the above-described image quality reproduction information is stored as image reproduction data to reproduce images and image quality as well. However, the form of the image processing system according to the present invention is not limited to these embodiments. The above-described image quality reproduction information may be stored in such a manner that it is added to an ASSET MANIFEST file including a list of image data in a recording medium that is inserted into a portable telephone, which will be described below.

In the following, there will be described a third image processing system according to a third embodiment of the image processing system of the present invention. The third image processing system is the same as the above-described first image processing system except that its image quality reproduction information is added to an ASSET MANIFEST file. Hereinafter, there will be explained only the different points, omitting redundant explanation.

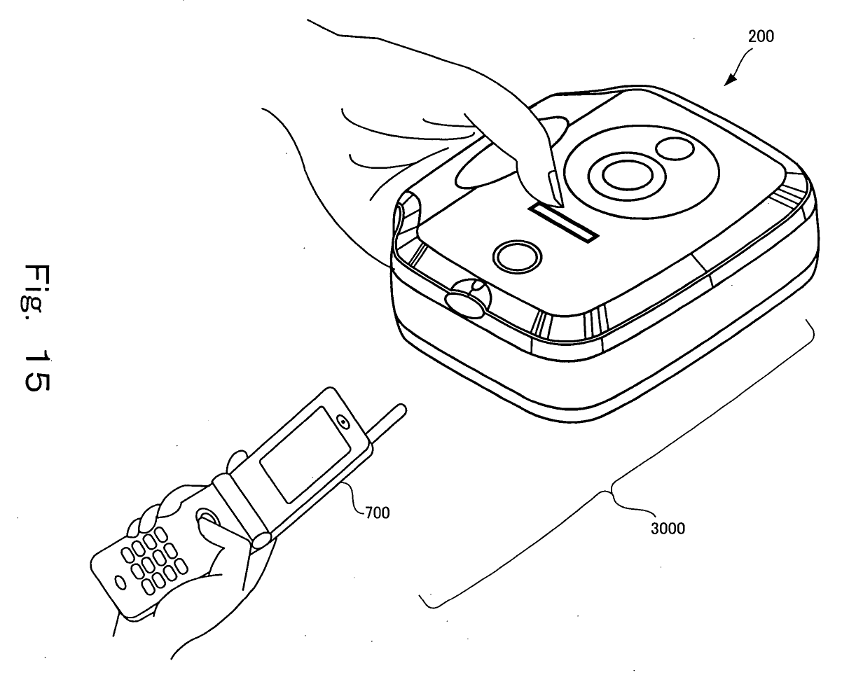

FIG. 15 is a perspective view of the third image processing system.

The third image processing system 3000 shown in FIG. 15 includes a portable telephone 700 according to a second embodiment of the image transmission apparatus of the present invention, which is different from the portable telephone 100 of the first image processing system 1000 shown in FIG. 3.

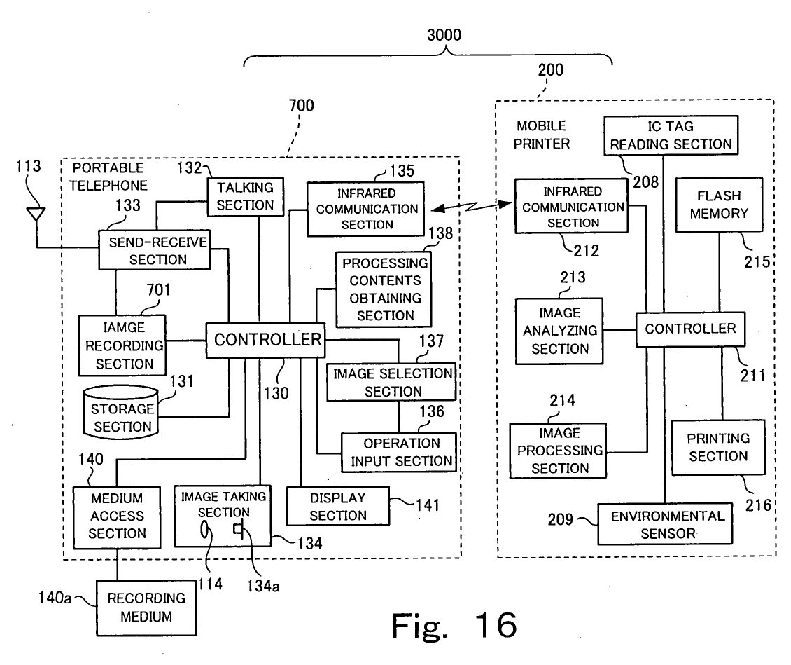

FIG. 16 is a block diagram of the third image processing system shown in FIG. 15. In FIG. 16, the same reference numbers as those of FIG. 6 denotes the same parts and thus the description of these will be omitted. In the third image processing system 3000 shown in FIG. 16, the portable telephone 700 has an image recording section 701 that is different from the image recording section 139 of the portable telephone 100 in the first image processing system 1000 shown in FIG. 6. The image recording section 701 corresponds to an example of the image recording section according to the present invention.

Hereinafter, the description will be focused on the image recording section 701, before that, there will be described a control program stored in a second embodiment of the image transmission program storage medium, which causes the portable telephone 700 to operate as the second embodiment of the image transmission apparatus of the present invention.

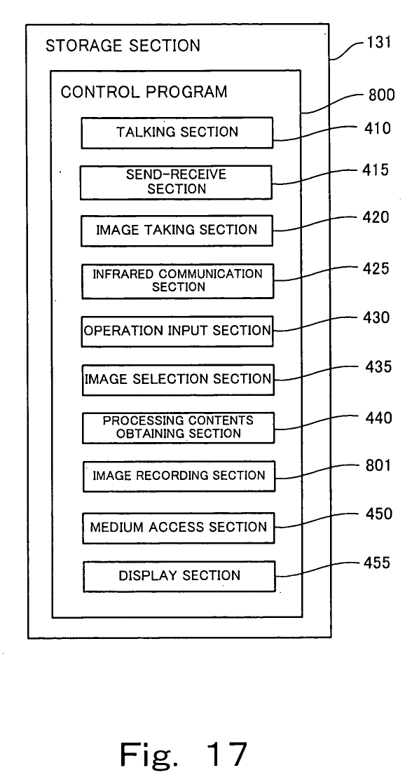

FIG. 17 is a conceptual view of a storage section storing a control program according to a second embodiment of the image transmission program storage medium of the present invention, which is also shown in FIG. 16. In FIG. 17, the same reference numbers as those of the control program 400 shown in FIG. 7 denotes the same parts and thus the description of these will be omitted.

The control program 800 according to the second embodiment of the image transmission program storage medium of the present invention has an image recording section 801 that is different from the image recording section 445 of the control program 400 shown in FIG. 7. The image recording section 801 is combined with hardware and software of the portable telephone 700 to form the image recording section 701 shown in FIG. 16.

Next, the image recording section 701 shown in FIG. 16 will be described.

In the third image processing system 3000, upon obtaining image data by image taking, the image recording section 701 stores the image data in a recording medium 140a through a medium access section 140. In the third image processing system 3000, the recording medium 140a corresponds to an example of the storage location according to the present invention.

Further, when new image data is recorded in the recording medium 140a through the medium access section 140, the image recording section 701 adds description of the new image data to an ASSET MANIFEST file that is a file other than a file storing the image data. The ASSET MANIFEST file includes at least a list of each piece of image data in the recording medium 140a. The ASSET MANIFEST file corresponds to an example of the “single common file” according to the present invention. When there is obtained image quality reproduction information for certain image data, the image recording section 701 adds the image quality reproduction information to an area near the description of the image data in the ASSET MANIFEST file.

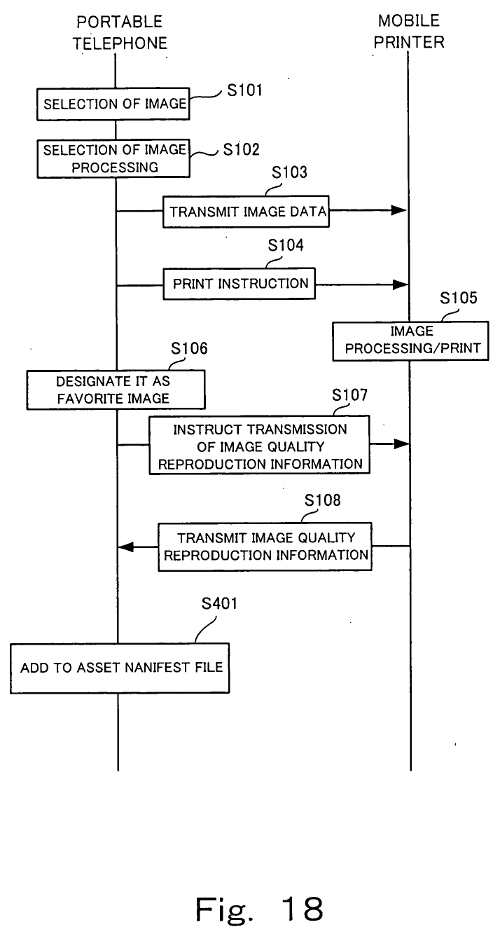

FIG. 18 is a view useful for understanding the selection and saving processing to be executed in the third image processing system, which is shown in FIG. 16. In FIG. 16, the same reference numbers as those of the selection and saving processing shown in FIG. 8 denotes the same parts.

In the selection and saving processing shown in FIG. 18, what is different from FIG. 8 is the processing (step S401) performed after the mobile printer 200 transmits image quality reproduction information to the portable telephone 700 via an infrared communication section 135 (step S108).

At step S401, the processing of adding the image quality reproduction information to the ASSET MANIFEST file is performed as described below.

First, there will be described the data structure of a recording medium in which image data and ASSET MANIFEST file are stored.

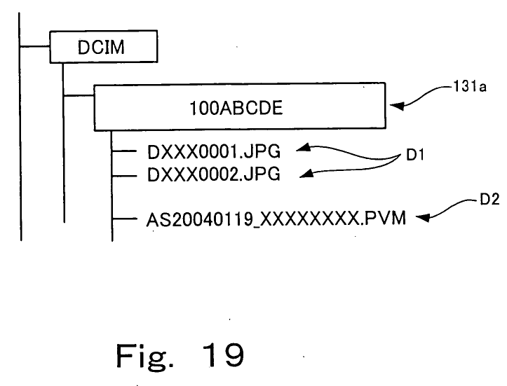

FIG. 19 is a diagram showing an example of the data structure of a recording medium in which image data and image quality reproduction information are stored during the selection and saving processing.

In this example shown in FIG. 19, pieces of image data D1 and an ASSET MANIFEST file D2 are stored in an image directory 131a named “100ABCD.” The image directory 131a stores a single ASSET MANIFEST file D2. Accordingly, every time new image data is stored in the image directory 131a, description of the new image data is added to the single ASSET MANIFEST file D2. When there is obtained image quality reproduction information with respect to image data contained in the image directory 131a, the image quality reproduction information is added to a part where identification information about the image data is described in the ASSET MANIFEST file D2.

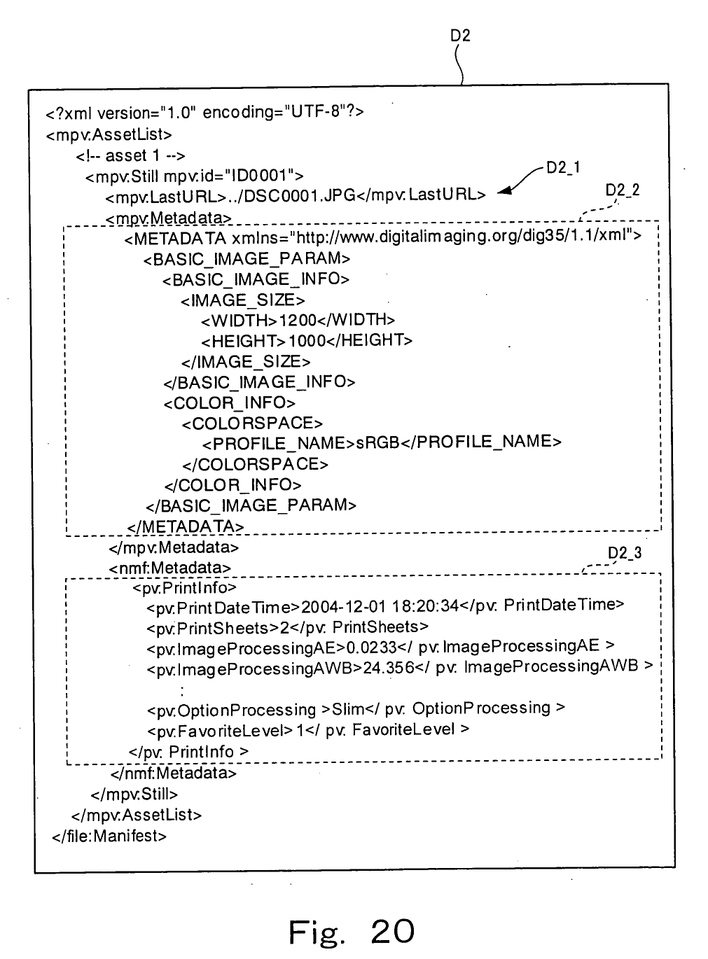

FIG. 20 is a diagram showing an example of the ASSET MANIFEST file.

Exemplarily extracted and shown in FIG. 20 is a part where image data named “DSC0001.JPG” is described. Actually, description of all pieces of image data in the image directory 131a shown in FIG. 19 is provided in this ASSET MANIFEST file.

As shown in FIG. 20, the ASSET MANIFEST file D2 includes, for each piece of image data stored in the image directory 131a, the followings: a data name part D2_1 where the name of image data is described, and a characteristic information part D2_2 where characteristic information that is composed of information such as the size of an image represented by the image data and the color space in which the image data defines colors. When there is obtained image quality reproduction information with respect to image data contained in the image directory 131a, the image quality reproduction information with respect to the image data is added, together with information that indicates that an image represented by the image data is selected as a “favorite image,” to a part following the characteristic information part D2_2. Therefore, there is formed an image quality reproduction information part D2_3 that describes the image quality reproduction information with respect to the image data. Further, when there is obtained image quality reproduction information with respect to each of plural pieces of image data contained in the image directory 131a, each of the obtained pieces of image quality reproduction information is added to a part following the characteristic information part D2_2 corresponding to each of the obtained image quality reproduction information.

As described above with reference to FIGS. 15 through 20, according to the third image processing system 3000, information to reproduce a “favorite image” and its image quality as well is stored in two files: a file containing image data that represents the “favorite image”; and an ASSET MANIFEST file to which image quality reproduction information that represents the image quality is added. These two files are stored in the recording medium 140a that is inserted into the portable telephone 700.

In the cases of the first and second embodiments described above, when there is obtained image quality reproduction information with respect to certain image data, the image quality reproduction information is made to associate with the image data that is large in size of about several megabytes so as to form image reproduction data to reproduce an image and its image quality as well. This image quality reproduction information is stored in the form of image reproduction data and accordingly, the processing for storing a large amount of data is required. In contrast, in the third embodiment, image quality reproduction information is added to a typically small-sized ASSET MANIFEST file to be stored in the form of ASSET MANIFEST file. For this reason, according to the third embodiment, it is possible to reduce processing time and power consumption required for storing. In addition, in the third image processing system 3000 as described above with reference to FIGS. 15 through 20, although the recording medium 140a being inserted into the portable telephone 700 is used as a storage location for storing image data and image quality reproduction information, the storage location may be a predetermined server like the first and second embodiments.

As described above, the third embodiment can also store information to reproduce a “favorite image” and its image quality as well, while reducing processing time and power consumption for storing in a manner more effective than the first and second embodiments.

According to the above-mentioned embodiments of the present invention, as an example of the image processing system referred to in the present invention, there is raised the image processing system in which the image transmission apparatus or the image processing apparatus is provided with the image selection section. However, it is noted that the image processing system referred to in the present invention is not restricted to the present embodiments. It is acceptable that the image processing system is provided with an image selection apparatus for selecting an image in accordance with an operation of a user, which is independently of the image transmission apparatus and the image processing apparatus, for instance. Or alternatively, it is acceptable that the image processing system is one in which the image selection section is provided on both the image transmission apparatus and the image processing apparatus, for instance.

Further, according to the above-mentioned embodiments of the present invention, as an example of the image transmission apparatus referred to in the present invention, there is raised the portable telephone having the image taking function. However, it is noted that the image transmission apparatus referred to in the present invention is not restricted to the present embodiments. It is acceptable that the image transmission apparatus is, for example, a digital camera having a communication function, and a mobile computer having the image taking function.

Furthermore, according to the above-mentioned embodiments of the present invention, as an example of the image processing capable of being instructed in execution by the portable telephone that is an example of the image transmission apparatus referred to in the present invention, there is raised three sorts of image processing of the soft focus, slimming and the trimming. However, it is noted that the processing is not restricted to the present embodiments. It is acceptable that the processing is concerned with, for example, image processing for removing lines and stains on one's face through using images around the lines and stains, and image processing for altering a color of one's hair to a desired color.

Still further, according to the above-mentioned embodiments of the present invention, as an example of the image selection section referred to in the present invention, there is raised the image selection section for selecting whether the printed image is selected as the “favorite image” whenever an image is printed by one. However, it is noted that the processing is not restricted to the present embodiments. It is acceptable that the image selection section referred to in the present invention is one in which after a plurality of images is printed, the “favorite image” is selected from among the pluralities of image.

As mentioned above, according to the present invention, it is possible to provide an image transmission apparatus capable of saving information capable of reproducing an image and the associated image quality as well suppressing time required for processing, an image processing apparatus, an image processing system, and an image transmission program storage medium storing an image transmission program that causes a computer having a function of an image transmission to operate as the transmission apparatus.

While the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

1. An image transmission apparatus comprising:
a transmission section that transmits images to an image processing apparatus for applying an image processing to the images upon a decision of processing contents;
an image selection section that select an image from among the images transmitted from the transmission section in accordance with operation;
a processing content obtaining section that obtains from the image processing apparatus the processing contents determined by the image processing apparatus for the image processing applied by the image processing apparatus to the image selected by the image selection section; and
an image recording section that stores in a predetermined storage location the image selected by the image selection section and the processing contents obtained by the processing content obtaining section with respect to the image with their association therebetween.

2. An image transmission apparatus according to claim 1, wherein the image transmission apparatus further comprises a medium access section that accesses to a predetermined recording medium, and the image recording section uses, as the storage location, the recording medium capable of being accessed by the medium access section.

3. An image transmission apparatus according to claim 1, wherein the image recording section uses, as the storage location, a recording location capable of being accessed through a communication network.

4. An image transmission apparatus according to claim 1, wherein the image transmission apparatus further comprises an image taking section that obtaining an image of a subject through image taking of the subject, and the transmission section transmits the image obtained by the image taking section to the image processing apparatus.

5. An image transmission apparatus according to claim 1, wherein the image recording section stores in the storage location the processing contents as a file other than a file of the image associated with the processing contents.

6. An image transmission apparatus according to claim 1, wherein, for a plurality of images being selected by the image selection section, the image recording section stores in the storage location a plurality of sets of processing contents with respect to the plurality of images as a single common file other than files of the plurality of images.

7. An image processing apparatus comprising:
a receiving section that receives images from an image transmission apparatus for transmitting images;
a processing content determining section that determines processing contents of image processing to be applied to the images received by the receiving section;
an image processing section that applies image processing for the processing contents determined by the processing content determining section to the image received by the receiving section;
an image selection section that select an image from among the images received by the receiving section in accordance with operation; and
a recording instruction section that transmits the processing contents determined by the processing content determining section with respect to the image selected by the image selection section to the image transmission apparatus and instructs the image transmission apparatus to record the image and the processing contents.

8. An image processing apparatus according to claim 7, wherein the image processing apparatus further comprises a printing section that outputs an image subjected to the image processing by the image processing section onto a predetermined sheet.

9. An image processing system comprising:
an image transmission apparatus that transmits images;
an image processing apparatus that receives images from the image transmission apparatus and applies an image processing to the images upon a decision of processing contents; and
an image selection section that selects an image in accordance with an operation,
wherein when the image selection section selects the image, the processing contents determined by the image processing apparatus for the image processing applied by the image processing apparatus with respect to the image is transmitted to the image transmission apparatus, and the image transmission apparatus stores in a predetermined storage location the image and the processing contents with their association therebetween.

10. An image processing system according to claim 9, wherein the image selection section selects an image from among the images transmitted by the image transmission apparatus, which is provided on the image transmission apparatus, in accordance with operation.

11. An image processing system according to claim 9, wherein the image selection section selects an image from among the images transmitted from the image transmission apparatus, which is provided on the image processing apparatus, in accordance with operation.

12. An image transmission program storage medium storing an image transmission program that causes a computer having a function of an image transmission to operate as an image transmission apparatus, when the image transmission program is executed in the computer, the image transmission apparatus comprising:
a transmission section that transmits images to an image processing apparatus for applying an image processing to the images upon a decision of processing contents;
an image selection section that select an image from among the images transmitted from the transmission section in accordance with operation;
a processing content obtaining section that obtains from the image processing apparatus the processing contents determined by the image processing apparatus for the image processing applied by the image processing apparatus to the image selected by the image selection section; and
an image recording section that stores in a predetermined storage location the image selected by the image selection section and the processing contents obtained by the processing content obtaining section with respect to the image with their association therebetween.
